(19) United States
(12) Patent Application Publication
(10) Pub. No.: US 2026/0070092 A1
(43) Pub. Date: Mar. 12, 2026

(54) MAGNETIC SLIDING KNIFE CLEANING DEVICE

(71) Applicant: Spillar LLC, Atlantic Beach, FL (US)

(72) Inventors: Marin Arsenault Spillar, Atlantic Beach, FL (US); David Allen Johnson, Coeur d'Alene, ID (US)

(73) Assignee: Spillar LLC, Atlantic Beach, FL (US)

(21) Appl. No.: 18/826,627

(22) Filed: Sep. 6, 2024

(51) Int. Cl. B08B 1/16; B08B 1/30

(52) U.S. Cl. CPC B08B 1/165; B08B 1/30

(57) ABSTRACT

A knife cleaning accessory device may include a first scraper and a second scraper connected at a connection section such that the first and second scrapers are facing each other. A magnet may be placed in one of the first or second scrapers and the magnet configured to secure the device to the knife. A slot may be positioned between the first and second scrapers. The slot may include an open end wherein the device may be placed on the blade of knife such that it rests on the spine of the knife. The device is moveable on the spine of the knife from a first position to a second position, and the first scraper and the second scraper are configured to remove matter on a blade of the knife as the device moves on the spine of the knife.

### BACKGROUND OF THE DISCLOSURE

### 1. Field of the Disclosure

The present disclosure relates to a device for cleaning a knife. More specifically, it relates to a device that is moveable along the length of the knife for removing food build up on the knife blade during cutting activities. For example, during fruit or vegetable cutting activities, the device may be easily moved along the blade to remove any fruit or vegetable build up on the blade.

### 2. Description of the Related Art

It's a well-known phenomenon that when someone is chopping food with a chef's knife, the food gets stuck and piles up on the blade due to the surface tension between the blade and the food. Because of this, the person chopping the food has to use their fingers to wipe away the pile of food accumulated on the blade. This is a safety issue because it can lead to inadvertent cutting of the user's fingers. Also, the user must often wash the food from their fingers and dry their hands before resuming their chopping.

Some knives include divots built into the blade to, in theory, disrupt surface tension and knock off the food from the blade. However, it is widely known that the divots do not work and the food still stays on the knife.

Knife glider devices that slide along the blade of a knife may also be used. These devices merely rest on the knife and do not have any additional forces to hold them on the knife. Therefore, as a person uses their hands to move the device along the knife, the glider device may improperly move or fall off the knife. This leads to inefficiencies in cutting as well as safety risks to user's hands.

Therefore, there is a need for device and method of assist in cleaning the food build up on a knife for safer, cleaner and efficient cutting.

### BRIEF SUMMARY OF THE DISCLOSURE

The invention of this disclosure provides a knife cleaning device that rests on the spine and both sides of the knife. The device includes a magnet that applies a magnetic force to a metallic knife blade and ensures the device stays on the knife. While cutting food, the device is moveable along the spine to easily and safely remove any food matter build up without the user touching the blade. Also, the magnet helps ensure the device moves along the blade without falling off. Therefore, the device is much easier and safer to use and eliminates the constant need to wash one's hands and use them to clean the knife blade.

In some aspects, the techniques described herein relate to a knife accessory device for cleaning a knife including: a first scraper extending between a first end and second end; a second scraper extending between a third end and a fourth end; a connection section including the first end of the first scraper connected to the third end of the second scraper such that the second end of the first scraper faces the fourth end of the second scraper; a magnet within the second scraper, the magnet configured to secure the device to the knife; and a slot configured to receive a spine of a knife, the slot including an open end between the second end of the first scraper and the fourth end of the second scraper, the slot extending between the first scraper and the second scraper and the slot extending from the connection section to the open end, wherein the device is moveable on the spine of the knife from a first position to a second position, and the first scraper and the second scraper are configured to remove matter on a blade of the knife as the device moves on the spine of the knife.

In some aspects, the techniques described herein relate to a device, further includes: a cavity in an outer surface of the connection section, the cavity configured to receive force and move the device along the spine.

In some aspects, the techniques described herein relate to a device, wherein the connection section further includes: a resting surface extending between the first scraper and the second scraper, the resting surface configured to abut the spine of the knife.

In some aspects, the techniques described herein relate to a knife accessory device including: a first scraper extending between a first end and second end; a second scraper extending between a third end and a fourth end; a connection section including the first end of the first scraper connected to the third end of the second scraper such that the second end of the first scraper faces the fourth end of the second scraper; a resting surface in the connection section, the resting surface configured to abut a spine of the knife; a magnet within the second scraper, the magnet configured to hold the device to the knife; and a slot configured extending from the resting surface to an open end between the second end of the first scraper and the fourth end of the second scraper, the slot extending between the first scraper and the second scraper, and the slot configured to receive a blade of the knife; wherein the device is moveable along a spine of a knife from a first position to a second position.

In some aspects, the techniques described herein relate to a device, further includes: a cavity in an outer surface of the connection section, the cavity configured to receive force and move the device along the spine.

In some aspects, the techniques described herein relate to a device, wherein the first and second scraper are configured to extend from the spine of the knife which is received in the slot, towards an edge of the blade of the knife.

In some aspects, the techniques described herein relate to a device, wherein the first and second scrapers are configured to remove matter accumulated on the blade of the knife.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a perspective view of the knife cleaning device according to this disclosure;

FIG. 2 is a front view of the knife cleaning device of FIG. 1;

FIG. 3 is a side view of the knife cleaning device of FIG. 1;

FIG. 4A is a cross-sectional side view, according to this disclosure, of the knife cleaning device of FIG. 1 along line V-V;

FIG. 4B depicts the view of FIG. 4A with device situated on a cutting knife;

FIG. 5 depicts an example of a knife cleaning device of FIG. 1 in a first position on a knife;

FIG. 6 depicts an example of a knife cleaning device of FIG. 1 in a second position on a knife;

FIG. 7 is a flow diagram of a method of making the device according to this disclosure; and

FIG. 8 is a flow diagram of a method of using the device according to this disclosure

### DETAILED DESCRIPTION OF THE DISCLOSURE

Certain terminology is used in the following description for convenience only and is not limiting. As used herein, the words “connected” or “coupled” are each intended to include integrally formed members, direct connections between two distinct members without any other members interposed therebetween and indirect connections between members in which one or more other members are interposed therebetween. The terminology includes the words specifically mentioned above, derivatives thereof, and words of similar import.

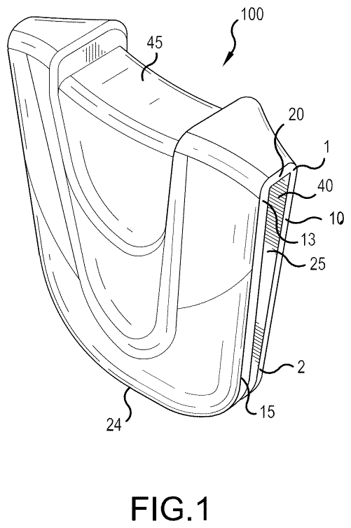

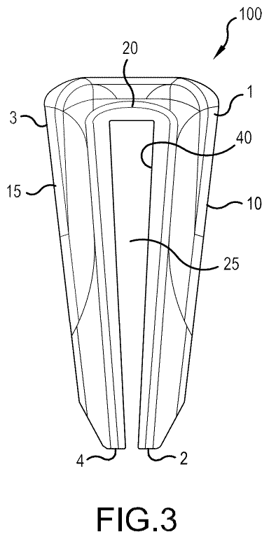

Referring now to the drawings in detail, wherein like numbers are used to indicate like elements throughout, FIGS. 1-6 depict a preferred embodiment of a knife accessory device or cleaning device 100 including a magnet 30, a first scraper 10, a second scraper 15, connection section 20, a slot 25, interior surface 40 and a cavity 45.

As shown in FIGS. 1-3, first scraper 10 includes a first end 1 and second end 2 while second scraper 15 includes a third end 3 and fourth end 4. First end 1 and third end 3 are connected at connection section 20. As shown, connection section 20 extends in a substantially lateral direction while first and second scrapers 10, 15 extend substantially longitudinally. Further, first and second scrapers 10, 15 extend in the same direction away from connection section 20 and the first scraper 10 faces the second scraper 15.

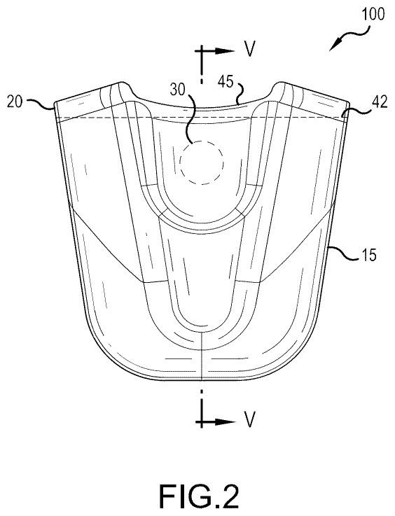

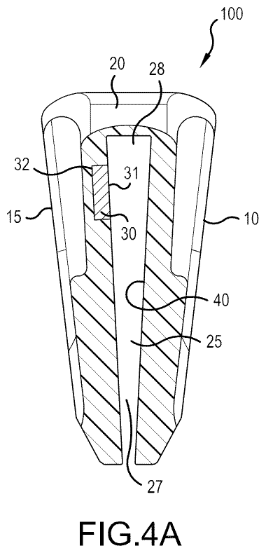

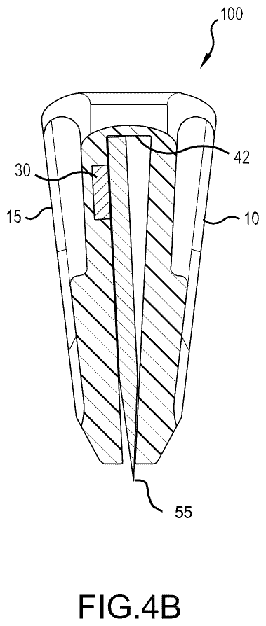

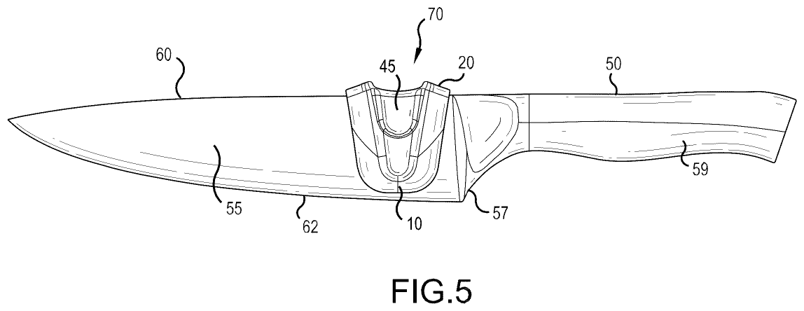

As shown in FIG. 5, first scraper 10 is spaced apart from second scraper 15 by connection section 20 and slot 25 which is an empty space until device 100 is placed on cutting knife 50. Interior surface 40 defines slot 25 with an open end 27 between the second end 2 of the first scraper 10 and second end 4 of the second scraper 15, and a closed end 28 at the connection section 20. In closed end 28, surface 40 includes resting surface 42 which extends the width, as shown in FIG. 2 and FIG. 4A, of device 100. Further, interior surface 40 defines slot 25 such that the width of the slot is greatest at closed end 28 and the width gradually decreases from the closed end 28 until its narrowest point at open end 27. Due to this shape, slot 25 may conform to the shape of a typical blade 55 of cutting knife 50 as shown in FIGS. 5 and 6. Thus, device 100 may be placed on knife 50 and rest thereon with the resting surface 42 abutting the spine 60 of knife 50 and internal surface 40 abutting at least one side of knife 50 but preferably both as shown in FIG. 4B. Further, slot 25 is configured to receive the knife spine 60 as the first portion of the knife that is inserted into the slot. Alternatively, knife 55 may be slid onto blade 55 starting with the point 58.

At least one scraper 10, 15 may include magnet 30 which secures device 100 to knife 50. As shown in FIG. 2, magnet 30 is placed in second scraper 15. As shown in FIG. 5, magnet 30 may form part of interior surface 40 and directly abut blade 55. That is, magnet surface 31 may be coplanar with the interior surface 40. Although one magnet is depicted in FIG. 5, an additional magnet may be placed in scraper 10 or alternatively, magnet 30 may be placed in first scraper 10 instead of second scraper 15.

The use of magnet 30 offers the benefit of making device 100 moveable from a first or ready position 70 in FIG. 5 to second or cleaning position 80 in FIG. 6 while the device 100 is secure to blade 55. When device 100 is moved, first and second scrapers 10, 15 function to remove any matter such as food that has accumulated on the blade. It is noted that the resting position 70 and active or cleaning position 80 shown in FIGS. 5 and 6 are examples of locations on the knife where device 100 may perform resting and cleaning. However, other cleaning and resting positions may exist on knife 55 as device 100 is moveable through the entire length of the blade and food matter may also accumulate along the entire length of the blade.

Cavity 45 is formed in outer surface 48 of the connection section 20. As shown in FIG. 2, cavity 45 may be directly over resting surface 42 and provides a space for the device 100 user to impart force to the device for movement lengthwise along the knife spine 60. Fingers may be placed in cavity 45 and may push on the bottom and side surfaces of the cavity to move the device forward and backward.

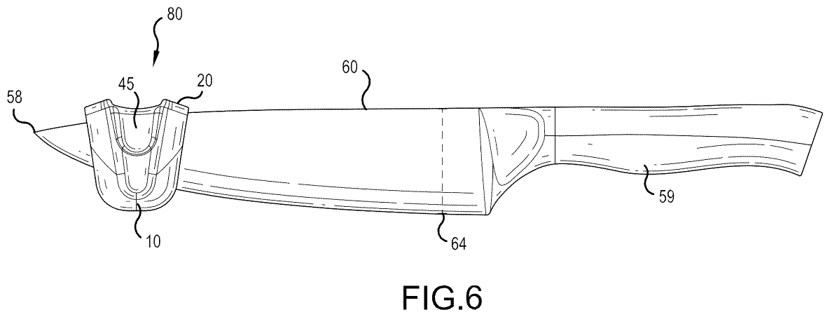

FIG. 7 depicts a method 200, according to this disclosure, of making device 100. In step 210, a raw material for formation of device 100 including scrapers 10, 15 and connection section 10 is provided. For ease of moving device 100 on blade 55, a hard, strong plastic with strong tensile strength such as high-density polyethylene (“HDPE”) is preferred. However, other hard materials such as ceramics, metals and metal alloys may be employed. It is noted that HDPE and other hard materials move more easily on blade 55 because these materials impart a lower force of friction, on blade 55, relative to softer materials such as soft rubber or silicon rubber. Further, a material such as HDPE that includes tensile strength is preferred so that the first and second scrapers 10, 15 may be easily separated, if needed, during placement of device 100 on knife blade 55 and return to their original form.

In step 220, at least one magnet 30 is provided of proper size to be contained within first or second scraper 10, 15 or both.

In step 230, the dimensions of device 100 are determined. Initially, the measurements of blade 55, on which device 100 will be placed, are determined. Although this disclosure refers to cutting knife 50 which is specifically used for cutting and dicing foods such as fruits and vegetables. It is contemplated that device 100 may be utilized with a variety of different sizes and types of knives and is useful in cutting any material that may accumulate on blade 55. The blade depth 64 as well as the blade width 65 may be measured.

The blade depth 64 is a measurement of the length of the blade 55 extending from spine 60 to blade edge 62. As shown in FIGS. 5 and 6, blade depth 64 may change along the length of the blade 55. That is, blade depth 64 may decrease as blade 55 extends from shoulder 57 to point 58. Therefore, blade depth 64 may be measured at both positions 70 and 80.

Once blade depth 64 measurements of blade 55 are performed, the longitudinal length of first and second scrapers 10, 15 may be determined. First and second scrapers 10, 15 are preferably less than or equal to the blade depth 64 at the knife shoulder 57 or position 70. Further, at position 80, the length of first and second scrapers 10, 15 is greater than the blade depth 64. The arrangement of the first and second scrapers 10, 15 having a length less than or equal to the blade depth 64 at position 70 allows device 100 including surface 42 to rest on the knife spine 60 during cutting operations. If the length of first and second scrapers 10, 15 was greater than blade depth 64, then the device would be, undesirably, cavitating relative to knife 50 during cutting operations.

A blade 55 of a knife 50 typically tapers from the spine 60 to edge 62. The width of the knife spine 60 as well as the tapering and width of edge 62 should also be measured. Slot 25 should be configured to accommodate the tapering such that the first and second scrapers 10, 15 either abut blade 55 or if one or both of scrapers 10, 15 are spaced from blade 55, scraper(s) 10, 15 are close enough to blade 55 to push any food or matter accumulated on blade 55 off the blade. As shown in FIGS. 4A and 4B, this may be accomplished by the formation of slot 25 which is also tapered such that it is wider at the resting surface 42 and narrows at the open end 27. Essentially, the interior surface 40 extends from the resting surface in both the lateral and longitudinal directions such that slot 25 is wider at resting surface 42 and narrower at open end 27.

In step 240, the production of device 100, including the features discussed above and shown in FIGS. 1-6, may be formed via additive manufacturing or injection molding. With respect to magnet 30, if injection molding is utilized, magnet 30 may be overmolded and magnet cavity 32 is formed during the overmolding process. If additive manufacturing is utilized, cavity 32 may be formed during manufacturing and magnet 30 may be secured to the cavity via friction fit or adhesives or epoxies.

As shown in FIGS. 4A and 4B, it is preferable that magnet surface 31 is coplanar with interior surface 40, however other configurations are contemplated such as magnet 30 being within at least one scraper 10, 15 and separated from blade 55 by the material, such as HDPE or metal, selected from the formation of the device.

Preferably, device 100 including scrapers 10, 15 and connection section 20 are formed as a one-piece, unitary structure. However, it is contemplated that device 100 may be formed in 2 or more pieces that are connected together.

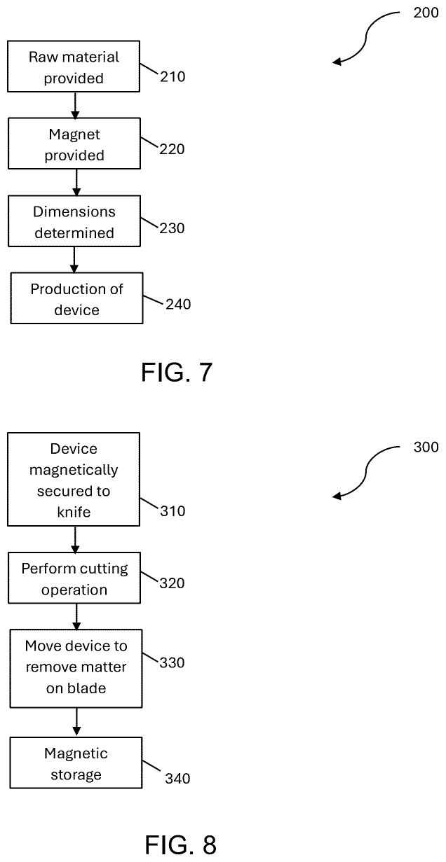

FIG. 8 is a flow diagram of a method 300, according to this disclosure, of cleaning a knife using device 100. In step 310, device 100 is magnetically secured to blade 55 by being placed over spine 60 such that slot 25 receives spine 62 first. Alternatively, a user may slide device 100 onto blade 55 by inserting point 58 into slot 25. Preferably, device 100 is initially placed on blade 55 at resting position 70 near the shoulder 57. However, device 100 may be placed on blade 55 at any position and then moved to position 70.

The example depicted in FIG. 4B shows blade 55 within in slot 25 at some point between first and second positions 80, 70. Depending on the size and thickness of the blade 55, both or one side of blade 55 will abut interior surface 40.

In step 320, a cutting operation may be performed by chopping, slicing, and/or dicing, etc. a food matter. After some time, the food matter may begin to accumulate on blade 55. It is noted that the cutting operation is not limited to food matter and may include the cutting of any matter using a knife 50 or other bladed cutting device. Also, the cutting operation may be performed by entities including a human, machine and/or robotics, etc.

In step 330, device 100 may be used to remove the food matter from knife 55. A user moves device 100 from the resting position 70 to the cleaning position 80. This movement may be performed manually. Cavity 45 is configured to receive a user's finger(s). A user may then hold handle 59 and push on cavity 45 to move or slide the device from the resting position to the cleaning position 80. As device 100 travels along the blade 55, first and second scrapers remove accumulated food matter from blade 55.

Although the movement of device 100 is discussed herein as manually moveable, it is also contemplated that a robotic arm or other device may be used to impart force to device 100 through cavity 45.

In step 340, device 100 may be stored on a knife rack, secured to the knife 55 or other metallic surface such as on a variety of kitchen appliances. Magnet 30 allows device 100 to be secured to a typical knife rack alongside knife 55. This is an added convenience for keeping track of device 100 in a user's kitchen or cutting space.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

1. A knife accessory device for cleaning a knife comprising:
a first scraper extending between a first end and second end;
a second scraper extending between a third end and a fourth end;
a connection section including the first end of the first scraper connected to the third end of the second scraper such that the second end of the first scraper faces the fourth end of the second scraper;
a magnet within the second scraper, the magnet configured to secure the device to the knife; and
a slot configured to receive a spine of a knife, the slot including an open end between the second end of the first scraper and the fourth end of the second scraper, the slot extending between the first scraper and the second scraper and the slot extending from the connection section to the open end;
wherein the device is moveable on the spine of the knife from a first position to a second position, and the first scraper and the second scraper are configured to remove matter on a blade of the knife as the device moves on the spine of the knife.

2. The device of claim 1, further comprises:
a cavity in an outer surface of the connection section, the cavity configured to receive force and move the device along the spine.

3. The device of claim 1, wherein the connection section further comprises:
a resting surface extending between the first scraper and the second scraper, the resting surface configured to abut the spine of the knife.

4. A knife accessory device comprising:
a first scraper extending between a first end and second end;
a second scraper extending between a third end and a fourth end;
a connection section including the first end of the first scraper connected to the third end of the second scraper such that the second end of the first scraper faces the fourth end of the second scraper;
a resting surface in the connection section, the resting surface configured to abut a spine of the knife;
a magnet within the second scraper, the magnet configured to hold the device to the knife; and
a slot configured extending from the resting surface to an open end between the second end of the first scraper and the fourth end of the second scraper, the slot extending between the first scraper and the second scraper, and the slot configured to receive a blade of the knife;
wherein the device is moveable along a spine of a knife from a first position to a second position.

5. The device of claim 4, further comprises:
a cavity in an outer surface of the connection section, the cavity configured to receive force and move the device along the spine.

6. The device of claim 4, wherein the first and second scraper are configured to extend from the spine of the knife which is received in the slot, towards an edge of the blade of the knife.

7. The device of claim 6, wherein the first and second scrapers are configured to remove matter accumulated on the blade of the knife.
